(19) United States
(12) Patent Application Publication
(10) Pub. No.: US 2009/0041510 A1
(43) Pub. Date: Feb. 12, 2009

(54) IMAGE FORMING APPARATUS

(76) Inventors: Naoki Imahashi, Mishima-shi (JP); Tomio Kondou, Numazu-shi (JP); Kimitoshi Yamaguchi, Numazu-shi (JP); Hitoshi Iwatsuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/189,384

(22) Filed: Aug. 11, 2008

(30) Foreign Application Priority Data
Aug. 9, 2007 (JP) 2007-207621

(51) Int. Cl. G03G 15/09

(52) U.S. Cl. 399/277

(57) ABSTRACT

An image forming apparatus is provided containing an image bearing member, a developer bearing member, and a developer control member being magnetic. The electrostatic latent image on the image bearing member is developed with a toner to form a toner image. The carrier includes magnetic core particles having a cover layer on the surfaces thereof, including fine particles having a weight average particle diameter of from 0.02 to 0.5 μm. The carrier has a weight average particle diameter of from 22 to 32 μm, and a ratio (E10/E100) of from 1.00 to 1.20. The ratio (E10/E100) is a ratio of a total energy (E10) to a total energy (E100) at a leading edge speed of the blade of 10 mm/s and 100 mm/s, respectively, measured using a power rheometer at an angle of approach of −5°.

### BACKGROUND OF THE INVENTION

1. Field of the Invention

The present invention relates to an electrophotographic image forming apparatus, such as copiers, printers, and facsimiles, using a two-component developer including a toner and a magnetic carrier.

2. Discussion of the Background

Electrophotographic developing methods are broadly classified into one-component developing methods using a one-component developer consisting essentially of a toner and two-component developing methods using a two-component developer including a toner and a carrier. The carrier typically includes glass beads or magnetic particles, the surfaces of which are covered with a resin, etc.

Two-component developing methods have very reliable charging performance than one-component developing methods because the carrier has a large area for triboelectrically charging the toner, thereby advantageously providing high quality images for an extended period of time. In addition, two-component developing methods have good toner supply performance to a developing area, thereby providing high-speed printing.

Two-component developing methods are also widely used in digital electrophotographic systems in which a latent image is formed on a photoconductor by a laser beam, etc. and the latent image is formed into a visible image.

In accordance with recent improvements in image resolution, highlight reproducibility, and image granularity, and colorization of images, dots (i.e., minimum units composing a latent image) are minimizing and becoming denser. Therefore, various attempts have been made to provide developing systems capable of reliably developing such minimized and dense dots, from the aspect of both image forming process and developer.

From the aspect of image forming process, proposed advantageous approaches involve narrowing a developing gap, thinning layers of a photoconductor, making the diameter of a writing beam smaller, and the like. However, concerns of cost increase and poor reliability may arise in these approaches.

From the viewpoint of developer, proposed advantageous approaches involve making the diameters of a toner and a carrier smaller.

For example, Unexamined Japanese Patent Application Publication No. (hereinafter “JP-A”) 58-144839 discloses a magnetic carrier including ferrite particles having spinel structure, and having an average particle diameter of less than 30 μm. Since this carrier is not covered with any resin, developing performance is poor and the life is short.

Japanese Patent No. 3029180 discloses an electrophotographic carrier having a 50% average particle diameter (D₅₀) of from 15 to 45 μm; and including particles having a particle diameter of less than 22 μm in an amount of from 1 to 20%, particles having a particle diameter of less than 16 μm in an amount of 3% or less, particles having a particle diameter of 62 μm or more in an amount of from 2 to 15%, and particles having a particle diameter of 88 μm or more in an amount of 2% or less. Further, the specific surface area S₁ measured by an air permeation method and the specific surface area S₂ calculated by the following equation:

S₂=(6/ρ·D₅₀)×10⁴
(ρ: specific gravity of the carrier)
   satisfy the following relation:

1.2≦S₁/S₂≦2.0

This small-sized carrier has the following advantages.
(1) The carrier has a relatively large surface area per unit volume. Therefore, toner particles are triboelectrically charged sufficiently, and therefore weakly-charged and reversely-charged toner particles are hardly produced. Accordingly, background fouling in that background portions of an image is soiled with undesired toner particles hardly occurs, and dots are reliably reproduced without scattering toner particles.
(2) Since the carrier has a relatively large surface area per unit volume and the background fouling hardly occurs, the average charge of toner particles may be reduced. Accordingly, high density images can be provided. In other words, a small-sized carrier and a small-sized toner are complementary to each other, so that the small-sized carrier exploits advantages of the small-sized toner.
(3) The small-sized carrier is capable of forming dense magnetic brushes with high fluidity. Therefore, the magnetic brushes hardly make undesirable traces on images.

However, a typical small-sized carrier has a disadvantage of easily causing carrier deposition in that carrier particles adhere to image portions and background portions of a latent image, which is undesirable. Therefore, it is difficult to provide high quality images for an extended period of time with such a small-sized carrier. Moreover, carrier particles adhered to a latent image may make flaws on a photoconductor or a fixing roller.

Specifically, a carrier having a weight average particle diameter of less than 30 μm has a drawback that carrier deposition may be easily caused, while providing non-grainy high quality images.

With respect to developer, use of a small-sized toner remarkably improves dot reproducibility. However, a developer including a small-sized toner causes unsolved problems of background fouling and low image density. Specifically, a small-sized toner for use in full-color images, which includes a resin having a low softening point so as to provide good color tone, tends to contaminate the surface of a carrier compared to a monochrome toner. Consequently, toner scattering and background fouling easily occur.

In accordance with speeding up of printing speed, carriers are required to be much more durable to provide reliable charging performance for an extended period of time.

The present inventors disclosed an electrophotographic carrier including magnetic core particles, the surface of each of which is covered with a resin layer, in JP-A 2005-250424. The carrier has a weight average particle diameter (Dw) of from 22 to 32 μm and a ratio (Dw/Dp) of the weight average particle diameter (Dw) to the number average particle diameter (Dp) in a range of 1<Dw/Dp<1.20. Furthermore, the carrier includes particles having a diameter of less than 20 μm in an amount of from 0 to 7% by weight, particles having a diameter of less than 36 μm in an amount of from 90 to 100% by weight, and particles having a diameter of less than 44 μm in an amount of from 98 to 100% by weight. This carrier produces high-image-density and low-granularity images without causing carrier deposition and background fouling.

On the other hand, in a two-component developing device, a toner and a magnetic carrier included in a developer contained in a developer container is triboelectrically charged. A developer bearing member, which includes a non-magnetic sleeve internally containing a magnetic field generating device, bears the charged developer on the surface thereof so as to convey the charged developer to a developing area which faces a photoconductor (i.e., an image bearing member) bearing an electrostatic latent image. In the developing area, an electric field is formed between the photoconductor and the sleeve so as to correspond to the electrostatic latent image, so that the toner included in the developer borne on the sleeve adheres to the photoconductor to form a toner image, i.e., develops the electrostatic latent image.

To reliably develop the electrostatic latent image, a proper amount of toner needs to be conveyed to the developing area. Therefore, a developer control member, such as a doctor blade, is provided facing the sleeve with a predetermined gap. The developer control member is configured to scrape off an excessive amount of developer on the sleeve and form a thin layer of the developer.

In is generally known that when the developer control member is magnetic, the toner is rapidly charged, resulting in improvement of image quality. JP-A 2005-37878 discloses a developing device including a developing sleeve for carrying a two-component developer and a developer control member, including a magnetic material, for controlling the thickness of the developer on the developing sleeve. The thickness Tup of the developer before passing through the developer control member and the gap Gd between the developer control member and the developing sleeve satisfy the following relation:

7<Tup/Gd<20

However, the present inventors confirmed that the combination of the carrier of JP-A 2005-250424 and the developing device of JP-A 2005-37878, both described above, does not provide high quality images with low granularity. This is because the small-sized carrier particles aggregate at periphery of the developer control member, thereby preventing the developer from being properly conveyed to the developing area. The aggregation of the carrier particles also degrades mixing performance of the toner and the carrier. Consequently, the toner is insufficiently charged, thereby causing background fouling.

### SUMMARY OF THE INVENTION

Accordingly, an object of the present invention is to provide an image forming apparatus capable of producing high-image-density and low-granularity images for an extended period of time.

These and other objects of the present invention, either individually or in combinations thereof, as hereinafter will become more readily apparent can be attained by an image forming apparatus, comprising:

a developer bearing member, being rotatable and internally comprising a magnetic member, configured to bear a two-component developer comprising a toner and a magnetic carrier; and

a developer control member, being magnetic, configured to control a layer thickness of the two-component developer borne on the developer bearing member;

wherein the electrostatic latent image on the image bearing member is developed with the toner to form a toner image by an action of an electric field formed between the image bearing member and the developer bearing member,

wherein the carrier comprises magnetic core particles having a cover layer on the surfaces thereof, the cover layer comprises fine particles having a weight average particle diameter of from 0.02 to 0.5 μm,

wherein the carrier has a ratio (E10/E100) of from 1.00 to 1.20, the ratio (E10/E100) is a ratio of a total energy (E10) at a leading edge speed of a blade of 10 mm/s to a total energy (E100) at a leading edge speed of the blade of 100 mm/s, measured using a power rheometer at an angle of approach of −5°.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of an image forming apparatus of the present invention;

FIG. 2 is a schematic view illustrating an embodiment of a process cartridge of the present invention;

FIG. 3 is a magnified schematic view illustrating an embodiment of the developing device for use in the image forming apparatus illustrated in FIG. 1; and

FIGS. 4A, 4B, and 4C are front, side, and bottom views illustrating embodiments of a blade of a powder rheometer, respectively.

### DETAILED DESCRIPTION OF THE INVENTION

The present invention will be described in detail with reference to drawings.

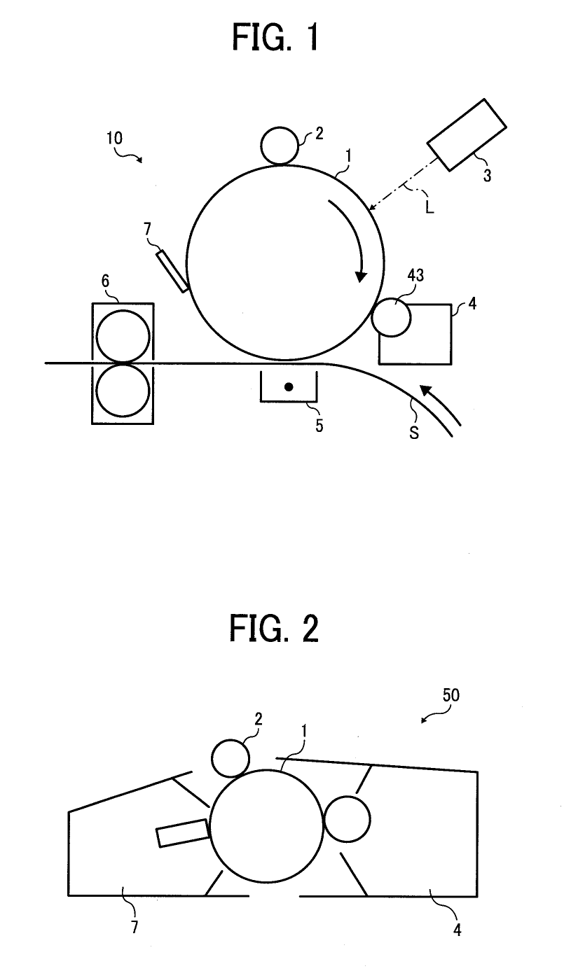

FIG. 1 is a schematic view illustrating an embodiment of an image forming apparatus of the present invention, which is an electrophotographic printer. A printer 10 illustrated in FIG. 1 includes a photoconductor 1 serving as an image bearing member; and a charging device 2, an optical writing device 3, a developing device 4, a transfer device 5, a cleaning device 7, and a decharging device, not shown, provided around the photoconductor 1. The printer 10 also includes a fixing device 6 provided on a left side of the transfer device 5 in FIG. 1.

The photoconductor 1 is driven to rotate in a clockwise direction in FIG. 1 by a driving device, not shown. The photoconductor 1 includes a cored bar made of aluminum, etc., and an organic photosensitive layer formed on the surface of the cored bar. The photosensitive layer includes a charge generation layer and a charge transport layer, and evenly charged to a positive or negative polarity by the charging device 2 while the photoconductor 1 rotates. The optical writing device 3 scans the photoconductor 1 with a laser light beam L based on image information transmitted from a personal computer, etc., not shown, so that the potential of an irradiated portion of the photoconductor 1 is attenuated. As a result, an electrostatic latent image, which has a smaller potential than background portions around the irradiated portion, is formed on the photoconductor 1. The electrostatic latent image thus formed on the photoconductor 1 passes a developing area, where the photoconductor 1 faces the developing device 4, along rotation of the photoconductor 1. At this time, a developer including a toner and a magnetic carrier borne by a developing sleeve 43 of the developing device 4 abrasively contacts the electrostatic latent image. Accordingly, the toner (e.g., a negatively-charged toner) included in the developer is electrostatically adhered to the electrostatic latent image, thereby forming a toner image.

A transfer area, where the photoconductor 1 faces the transfer device 5, is formed on a downstream side from the developing area relative to a direction of rotation of the photoconductor 1. When the toner image formed on the photoconductor 1 passes the transfer area along rotation of the photoconductor 1, a transfer sheet S is fed from a paper feed device, not shown, in synchronization with entry of the toner image into the transfer area, so that the toner image is superimposed on the transfer sheet S. The toner image is then electrostatically transferred onto the transfer sheet S due to an electric field formed between the irradiated portions of the photoconductor 1 and the transfer device 5. The transfer sheet S electrostatically adheres to the photoconductor 1 when transferring the toner image, however, subsequently separates therefrom by the action of weight and rigidity of the transfer sheet S and a separation mechanism, not shown. The transfer sheet S onto which the toner image is thus electrostatically transferred is conveyed from the transfer area to the fixing device 6.

In the fixing device 6, a heating roller which internally contains a heat source and a pressing roller form a fixing nip therebetween. The heating and pressing rollers are driven to rotate so that the surfaces thereof move in the same direction at an area where the heating and pressing rollers contact with each other. The transfer sheet S conveyed to the fixing nip in the fixing device 6 is then conveyed along a direction of movement of the surfaces of the rollers. At this time, the toner image is fixed on the transfer sheet S by application of pressure and heat in the fixing nip. The transfer sheet S having the fixed toner image thereon is discharged from the image forming apparatus by a paper discharge device, not shown.

When the surface of the photoconductor 1 passes an area where the photoconductor 1 faces the cleaning device 7, after passing the transfer area, residual toner particles remaining on the photoconductor 1 are removed by the cleaning device 7. Subsequently, residual charges remaining on the photoconductor 1 are removed by the decharging device, not shown, to prepare for the next image forming operation.

The charging device 2 illustrated in FIG. 1 employs a contact charging method in which a bias member such as a charging roller to which a charging bias is applied is brought into contact with the photoconductor 1. Alternatively, the charging device 2 may employ a non-contact charging method using a charger, etc.

The optical writing device 3 illustrated in FIG. 1 forms an electrostatic latent image by emission of a laser light beam. Alternatively, an LED array emitting an LED light beam is also usable for the optical writing device 3. Furthermore, an electrostatic latent image may be formed by an ion injection.

The transfer device 5 illustrated in FIG. 1 employs a non-contact method. Alternatively, the transfer device 5 may employ a roller contact method in which a transfer roller to which a transfer bias is applied is brought into contact with the photoconductor 1, a belt contact method in which a transfer belt is brought into contact with the photoconductor 1, or the like.

The cleaning device 7 illustrated in FIG. 1 employs a cleaning blade for scraping off residual toner particles. Alternatively, the cleaning device 7 may employ a brush or roller to which a cleaning bias is applied, provided in contact with the photoconductor 1, for electrostatically collect residual toner particles.

The photoconductor 1 illustrated in FIG. 1 has a drum shape. Alternatively, the photoconductor 1 may have a belt shape.

The printer 10 illustrated in FIG. 1 is a printer in which the photoconductor 1 and the peripheral devices are individually provided. Alternatively, the photoconductor 1 and the peripheral devices maybe integrally contained in a common casing as one unit, as a process cartridge 50 illustrated in FIG. 2, for example. The process cartridge 50 includes the photoconductor 1, the charging device 2, the developing device 4, and the cleaning device 7, and is detachably attachable to image forming apparatuses.

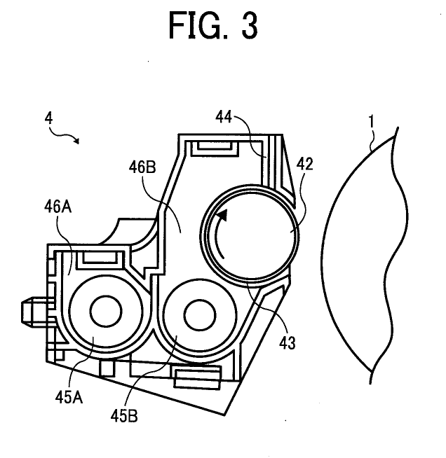

FIG. 3 is a magnified schematic view illustrating an embodiment of the developing device 4 described above. The developing device 4 includes a developer containing chamber, in which screws 45A and 45B are provided so as to agitate and convey the developer. A developing sleeve 43 is provided so that part of the developing sleeve 43 is exposed so as to face the photoconductor 1.

A partition is provided in the developer containing chamber to form chambers 46A and 46B. A fresh toner is supplied from a toner supply opening provided on the chamber 46A, which is much apart from the developing sleeve 43. The fresh toner thus supplied is sufficiently mixed with a carrier while being conveyed in a longitudinal direction in the chamber 46A, so that the unmixed fresh toner is not supplied to the developing sleeve 43 immediately after supplied from the toner supply opening. Subsequently, the toner thus sufficiently mixed with the carrier is fed to the chamber 46B through an opening, not shown, so as to be supplied to the developing sleeve 43.

The developing sleeve 43 is a non-magnetic cylindrical member made of aluminum, non-magnetic stainless, or the like, the surface of which has proper convexities and concavities formed by sandblasting or forming grooves. The developing sleeve 43 is driven to rotate by a driving motor, not shown, at a predetermined or desired linear velocity. The developing sleeve 43 internally contains a magnetic roller 42 to which a magnetic member having a plurality of magnetic poles is fixed, so as to bear and convey the developer along rotation thereof. The magnetic roller 42 includes a plurality of magnetic poles, as described above, such as a developing pole configured to form magnetic brushes of the developer in the developing area, a drawing pole configured to draw up the developer to the developing sleeve 43, and a conveyance pole configured to convey the developer. The number of the magnetic poles is typically 5 to 10.

A doctor blade 44, serving as a developer control member, configured to control the amount of the developer on the developing sleeve 43 is provided on an upstream side from the developing area relative to a direction of rotation of the developing sleeve 43. After the doctor blade 44 controls so that a desired amount of the developer is on the developing sleeve 43, the magnetic roller 42 contained in the developing sleeve 43 forms magnetic brushes of the developer thereon. The magnetic brushes thus formed contact an electrostatic latent image formed on the photoconductor 1 in the developing area.

The doctor blade 44 includes a magnetic material. When the doctor blade 44 is magnetic, the toner may be capable of quickly charged. Furthermore, a gap between the doctor blade 44 and the developing sleeve 43 can be widened, thereby reducing mechanical stress applied to the developer when passed under the doctor blade 44. Accordingly, such a magnetic doctor blade provides reliable charge giving property for an extended period of time.

The developing sleeve 43 is connected to a power source, not shown, configured to apply a developing bias to form a developing electric field in the developing area. The charged toner included in the developer on the developing sleeve 43 is adhered to the electrostatic latent image on the photoconductor 1 due to the developing electric field, thereby forming a toner image.

The developing sleeve 43 preferably has a linear velocity of from 1.1 to 3.0 times, more preferably from 1.5 to 2.5 times, that of the photoconductor 1. When the linear velocity is too small, the resultant image may have low image density. When the linear velocity is too large, toner scattering and image distortion may be caused. The optimum value of the developing gap Gp between the photoconductor 1 and the developing sleeve 43 depends on the diameter of the carrier and the amount of the developer drawn up. However, preferably, the developing gap Gp is in a narrow range of from 0.2 to 0.5 mm, so as to provide sufficient developing performance.

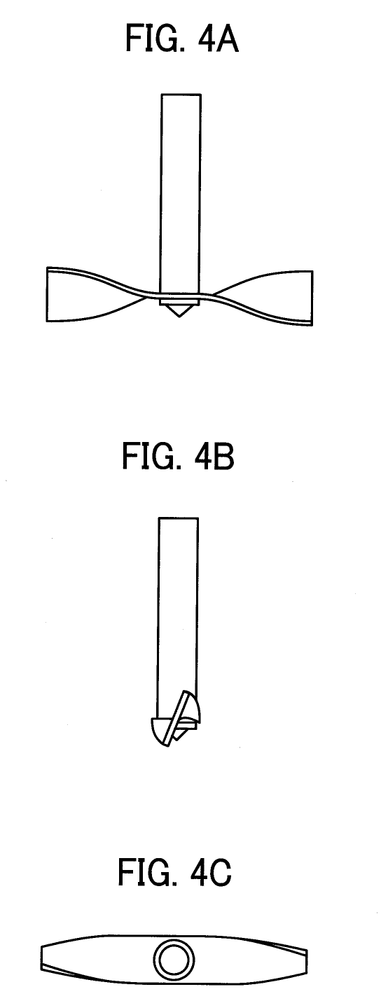

In the present invention, the total energy of a carrier is measured by a powder rheometer FT4 POWDER RHEOMETER (from Freeman Technology). A sample container for use in the measurement is a cylinder having a volume of 25 ml, an inner diameter of 24 mm, and a height of 50 mm. A blade for use in the measurement is a propeller-shaped blade having a diameter of 23.5 mm and a height of 6 mm (from Freeman Technology). FIGS. 4A, 4B, and 4C are front, side, and bottom views illustrating the propeller-shaped blade, respectively.

The measurement is performed as follows. First, the sample container is filled with carrier particles. The blade is gently moved into the sample container while being rotated at an angle of approach of 5°. This process is called “conditioning”. The conditioning allows the sample container to be very evenly filled with the carrier particles.

Next, the blade is helically moved into the sample container to reach a depth of 45 mm from the surface of the filled carrier particles, at a leading edge speed of the blade of 100 mm/s and an angle of approach of −5°. Force acting on the blade is resolved into vertical load and rotational torque, and the vertical load and rotational torque are continuously measured so that energy gradient (mJ/mm) is calculated therefrom. Total energy E100 (mJ) needed for the above-described movement of the blade is calculated by integrating the energy gradient with respect to distance. Here, the angle of approach is an angle of a helical path along which a leading edge of the blade moves.

After performing the conditioning again, the blade is helically moved into the sample container to reach a depth of 45 mm from the surface of the filled carrier particles, at a leading edge speed of the blade of 10 mm/s and an angle of approach of −5°. Total energy E10 (mJ) is calculated in the same manner, and the ratio (E10/E100) of E10 to E100 is calculated.

The carrier for use in the present invention has a ratio (E10/E100) of from 1.0 to 1.2. When the ratio (E10/E100) is too small, the carrier and a toner cannot be sufficiently mixed, and therefore the toner cannot be quickly charged, causing toner scattering. When the ratio (E10/E100) is too large, carrier particles tend to aggregate at periphery of the developer control member, thereby preventing the developer from being properly conveyed to the developing area. The aggregation of carrier particles also degrades mixing performance of the toner and the carrier. Consequently, the toner is insufficiently charged, thereby causing background fouling.

The ratio (E10/E100) is adjustable by properly setting the diameter and amount of fine particles added to the cover layer of the carrier, the composition and thickness of the cover layer of the carrier, the weight average particle diameter of the carrier, the ratio of the weight average particle diameter to the number average particle diameter of the carrier, and the like.

The carrier for use in the present invention has a weight average particle diameter (Dw) of from 22 to 32 μm, and preferably from 23 to 30 μm. When Dw is too large, an electrostatic latent image may not be reliably reproduced, thereby degrading granularity of the resultant image, while carrier deposition is hardly caused. Furthermore, background fouling is easily caused when the toner concentration is high. Here, carrier deposition is an undesirable phenomenon in that carrier particles adhere to image portions and background portions of latent image. Carrier deposition very easily occurs as the electric field applied becomes stronger. Carrier deposition is more likely to occur in background portions compared to image portions, because the electric field is weakened by development of a latent image by a toner in the image portions. Carrier deposition may make flaws on a photoconductor and/or a fixing roller, which is undesirable.

The ratio (Dw/Dp) of the weight average particle diameter (Dw) to the number average particle diameter (Dp) is preferably from 1.0 to 1.2. When the ratio (Dw/Dp) is too large, too large an amount of fine particles are included, resulting in carrier deposition.

The carrier for use in the present invention preferably includes particles having a diameter of from 0.02 to 20 μm in an amount of 7% by weight or less, and more preferably 5% by weight or less. When the amount is too large, the carrier may have too broad a particle diameter distribution, and therefore magnetic brushes thereof may include particles having a small magnetic moment, resulting in carrier deposition. From the viewpoint of productivity, the carrier preferably includes particles having a diameter of from 0.02 to 20 μm in an amount of 0.5% by weight or more.

Furthermore, the carrier for use in the present invention preferably includes particles having a diameter of from 0.02 to 36 μm in an amount of 90% by weight or more, and more preferably 92% by weight or more, so that the carrier has a narrow particle diameter distribution. Such a carrier has a narrow magnetic moment distribution, thereby preventing the occurrence of carrier deposition.

The number average particle diameter (Dp) and the weight average particle diameter (Dw) are respectively calculated by the following equations:

Dp={1/Σ(n)}×{Σ(nD)}

Dw={1/Σ(nD³)}×{Σ(nD⁴)}

wherein D represents a representative diameter (μm) of a channel and n represents the number of particles in the channel. The “channel” is a unit length uniformly dividing the particle diameter range into a measurement unit, in a particle diameter distribution diagram. In the present invention, the unit length is 2 μm.

As the representative diameter of the channel, the minimum diameter in the channel is adopted. The particle diameter distribution of a carrier can be measured using an instrument MICROTRAC HRA9320-X100 (manufactured by Honeywell International Inc.), for example.

As the core particles, pulverized particles of a magnetic material can be used. When the magnetic material is ferrite, magnetite, or the like, core particles can be prepared by classifying primary particles, calcining the classified particles, classifying again the calcined particles so as to obtain different-sized particle groups, and mixing plural different-sized particles groups.

Core particles can be classified using any known classifiers such as a screening classifier, a gravitational classifier, a centrifugal classifier, and an inertial classifier. An inertial classifier is a classifier using an inertial force. From the viewpoint of productivity, wind power classifiers, including gravitational classifiers, centrifugal classifiers, and inertial classifiers, are preferably used.

The core particles for use in the present invention have a magnetization of from 65 to 120 emu/g, preferably 80 to 100 emu/g when a magnetic field of 1 kOe is applied. Such core particles hardly cause carrier deposition. When the magnetization is too small, carrier deposition may easily occur.

The magnetization of core particles can be measured using a B-H tracer BHU-60 (from Riken Denshi Co., Ltd.) as follows. First, a cylindrical cell is filled with 1 g of core particles and the cell is set in the B-H tracer. A magnetic field is applied to the cell while the field strength is gradually increased to 3 kOe and then gradually decreased to 0. Subsequently, a magnetic field having a reverse direction is applied thereto while the field strength is gradually increased to 3 kOe and then gradually decreased to 0. A magnetic field having the same direction as the first magnetic field is applied again. Thus, a B-H curve is obtained. A magnetization when the field strength is 1 kOe is determined from the B-H curve.

Specific examples of such core particles having a magnetization of from 65 to 120 emu/g, preferably 80 to 100 emu/g when a magnetic field of 1 kOe is applied include, but are not limited to, ferromagnets such as iron and cobalt, magnetite, hematite, Li ferrite, Mn—Zn ferrite, Cu—Zn ferrite, Ni—Zn ferrite, Ba ferrite, and Mn ferrite.

A ferrite is typically represented by the following formula:

(MO)ₓ(NO)_{y}(Fe₂O₃)_{z}

wherein x, y, and z represent composition ratios (i.e., x+y+Z=100% by mole), and each of M and N independently represents Ni, Cu, Zn, Li₂, Mg, Mn, Sr, or Ca. Accordingly, a ferrite is a complete mixture of a metal oxide and an iron (III) oxide.

The cover layer of the carrier includes fine particles having a weight average particle diameter of from 0.02 to 0.5 μm. When the cover later includes no fine particles, frictional force between each carrier particles may be hardly relaxed, and therefore the ratio (E10/E100) may easily exceed 1.20. When the weight average particle diameter is too small, the cover layer may be insufficiently reinforced, and the ratio (E10/E100) may easily exceed 1.20. When the weight average particle diameter is too large, the fine particles may easily release from the cover layer, resulting in poor effect of addition of the fine particles. The particle diameter distribution of fine particles can be measured using NANOTRAC® PARTICLE SIZE ANALYZER UPA-EX150 (from Nikkiso Co., Ltd.).

The content of the fine particles included in the cover layer may be determined in consideration of particle diameter and specific surface area. However, the cover layer preferably includes the fine particles in an amount of from 2 to 200, preferably 5 to 150, more preferably 10 to 100% by weight based on solid components of resins in the cover layer (including all subvalues). When the amount is too small, the fine particles may not sufficiently improve abrasion resistance of the cover layer. When the amount is too large, the fine particles may easily release from the cover layer, thereby degrading charging stability.

In the present invention, silicone resins having at least one of the following repeating units are preferably included in the cover layer:

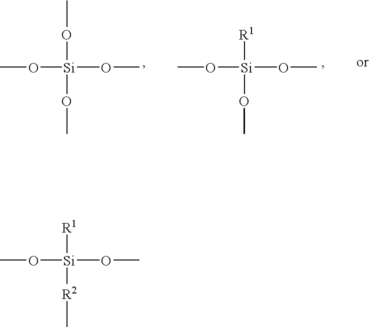

wherein R¹ represents a hydrogen atom, a halogen atom, a hydroxyl group, a methoxy group, a lower alkyl group having 1 to 4 carbon atoms, or an aryl group (e.g., phenyl group, tolyl group); and R² represents an alkylene group having 1 to 4 carbon atoms or an arylene group (e.g., phenylene group).

The aryl group preferably has 6 to 20, more preferably 6 to 14, carbon atoms. Specific examples of the aryl groups include aryl groups derived from benzene (such as phenyl group); those derived from condensed polycyclic aromatic hydrocarbons such as naphthalene, phenanthrene, and anthracene; and those derived from chain polycyclic aromatic hydrocarbons such as biphenyl and terphenyl. The aryl group may have a substituent group.

The arylene group preferably has 6 to 20, more preferably 6 to 14, carbon atoms. Specific examples of the arylene groups include arylene groups derived from benzene (such as phenylene group); those derived from condensed polycyclic aromatic hydrocarbons such as naphthalene, phenanthrene, and anthracene; and those derived from chain polycyclic aromatic hydrocarbons such as biphenyl and terphenyl. The arylene group may have a substituent group.

In the present invention, straight silicone resins can be used as the silicone resin. Specific examples of useable commercially available straight silicone resins include, but are not limited to, KR271, KR272, KR282, KR252, KR255, and KR152 (from Shin-Etsu Chemical Co., Ltd.); and SR2400, SR2406, and SR2411 (from Dow Corning Toray Silicone Co., Ltd.).

In the present invention, modified silicone resins can be also used as the silicone resin. Specific examples of the modified silicone resins include, but are not limited to, epoxy-modified silicone resin, acryl-modified silicone resin, phenol-modified silicone resin, urethane-modified silicone resin, polyester-modified silicone resin, and alkyd-modified silicone resin.

Specific examples of useable commercially available epoxy-modified silicone resin include, but are not limited to, ES1001N (from Shin-Etsu Chemical Co., Ltd.) and SR2115 (from Dow Corning Toray Silicone Co., Ltd.). Specific examples of useable commercially available acryl-modified silicone resin include, but are not limited to, KR5208 (from Shin-Etsu Chemical Co., Ltd.). Specific examples of useable commercially available polyester-modified silicone resin include, but are not limited to, KR5203 (from Shin-Etsu Chemical Co., Ltd.). Specific examples of useable commercially available alkyd-modified silicone resin include, but are not limited to, KR206 (from Shin-Etsu Chemical Co., Ltd.) and SR2110 (from Dow Corning Toray Silicone Co., Ltd.). Specific examples of useable commercially available urethane-modified silicone resin include, but are not limited to, KR305 (from Shin-Etsu Chemical Co., Ltd.).

Further, the following resins can be used in combination with the silicone resin: styrene resins such as polystyrene, polychlorostyrene, poly(α-methylstyrene), styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylate copolymers (e.g., styrene-methyl acrylate copolymer, styrene-ethyl acrylate copolymer, styrene-butyl acrylate copolymer, styrene-octyl acrylate copolymer, styrene-phenyl acrylate copolymer), styrene-methacrylate copolymers (e.g., styrene-methyl methacrylate copolymer, styrene-ethyl methacrylate copolymer, styrene-butyl methacrylate copolymer, styrene-phenyl methacrylate copolymer), styrene-methyl α-chloroacrylate copolymer, and styrene-acrylonitrile-acrylate copolymer; and other resins such as epoxy resin, polyester resin, polyethylene, polypropylene, ionomer resin, polyurethane resin, ketone resin, acrylic resin, ethylene-ethyl acrylate resin, xylene resin, polyamide resin, phenol resin, polycarbonate resin, melamine resin, and fluorocarbon resin.

The cover layer may further include an aminosilane coupling agent, so that the resultant carrier is highly durable. Specific examples of usable aminosilane coupling agents include the following compounds, but are not limited thereto:

H₂N(CH₂)₃Si(OCH₃)₃

H₂N(CH₂)₃Si(OCH₂H₅)₃

H₂N(CH₂)₃Si(CH₃)₂(OCH₂H₅)

H₂N(CH₂)₃Si(CH₃)(OCH₂H₅)₂

H₂N(CH₂)₂NHCH₂Si(OCH₃)₃

H₂N(CH₂)₂NH(CH₂)₃Si(CH₃)(OCH₃)₂

H₂N(CH₂)₂NH(CH₂)₃Si(OCH₃)₃

(CH₃)₂N(CH₂)₃Si(CH₃)(OCH₂H₅)₂

(C₄H₉)₂N(CH₂)₃Si(OCH₃)₃

The cover layer preferably includes the aminosilane coupling agent in an amount of from 0.001 to 30% by weight, more preferably 0.01 to 25% by weight and most preferably 0.1 to 20% by weight.

The cover layer can be formed on the surface of the core particle by any known methods such as a spray dry method, a dipping method, and a powder coating method. A fluidized bed coating device is effective for forming a uniform layer.

The cover layer typically has a thickness of from 0.02 to 1 μm, and preferably from 0.03 to 0.8 μm. Since the cover layer is extremely thinner than the particle diameter of the core particle, the particle diameter of the surface-covered carrier particle is substantially same as that of the core particle.

As described above, the carrier for use in the present invention has the cover layer including fine particles having a particle diameter of from 0.02 to 0.5 μm, and the ratio (E10/E100) of from 1.00 to 1.20, which is a ratio of a total energy (E10) at a leading edge speed of the blade of 10 mm/s to a total energy (E100) at a leading edge speed of the blade of 100 mm/s, measured using a power rheometer at an angle of approach of −5°. Such a carrier can be well mixed with a toner, and therefore the toner can be quickly charged and reliably keep a proper charge.

The developer for use in the present invention mainly includes the carrier described above and a toner, and optionally includes a lubricant such as a wax, a release agent such as silicone or a fluorinated material, and a fluidity improving agent such as an inorganic particulate material.

The toner may be a typical toner including a binder resin mainly including a thermoplastic resin, a colorant, a particulate material, a charge controlling agent, a release agent, and the like. The toner can be manufactured by a polymerization method, a granulation method, and the like. The toner may have either an irregular shape or a spherical shape. The toner may be either magnetic or non-magnetic.

Specific examples of usable binder resins of the toner include, but are not limited to, styrene resins such as homopolymers of styrene and derivatives thereof (e.g., polystyrene, polyvinyl toluene) and styrene copolymers (e.g., styrene-p-chlorostyrene copolymer, styrene-propylene copolymer, styrene-vinyl toluene copolymer, styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleic acid copolymer, styrene-maleate copolymer); and other resins such as polymethyl methacrylate, polybutyl methacrylate, polyvinyl chloride, polyvinyl acetate, polyethylene, polypropylene, polyester, polyurethane, epoxy resin, polyvinyl butyral, polyacrylic acid resin, rosin, modified rosin, terpene resin, phenol resin, aliphatic hydrocarbon resin, aromatic petroleum resin, chlorinated paraffin, and paraffin wax. These resins can be used alone or in combination.

The polyester resin has a lower melt-viscosity compared to the styrene or acrylic resins while keeping preservation stability. The polyester resin can be formed from a polycondensation reaction between an alcohol and a carboxylic acid.

Specific examples of the alcohol for preparing a polyester resin include, but are not limited to, diols (e.g., polyethylene glycol, diethylene glycol, triethylene glycol, 1,2-propylene glycol, 1,3-propylene glycol, 1,4-propylene glycol, neopentyl glycol, 1,4-butenediol), 1,4-bis(hydroxymethyl)cyclohexane, bisphenol A, hydrogenated bisphenol A, etherified bisphenol A (e.g., polyoxyethylenated bisphenol A, polyoxypropylenated bisphenol A), these divalent alcohols substituted with a saturated or unsaturated hydrocarbon group having 3 to 22 carbon atoms, and other divalent alcohols; and polyols having 3 or more valences (e.g., sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Specific examples of the carboxylic acid for preparing a polyester resin include, but are not limited to, monocarboxylic acids (e.g., palmitic acid, stearic acid, oleic acid); divalent organic acids (e.g., maleic acid, fumaric acid, mesaconic acid, citraconic acid, terephthalic acid, cyclohexane dicarboxylic acid, succinic acid, adipic acid, sebacic acid, malonic acid), these divalent organic acids substituted with a saturated or unsaturated hydrocarbon group having 3 to 22 carbon atoms, dimers of an acid anhydride or a lower alkyl ester thereof and linolenic acid, and other divalent organic acids; and polycarboxylic acid monomers having 3 or more valences such as 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 3,3-dicarboxymethyl butanoic acid, tetracarboxymethyl methane, 1,2,7,8-octanetetracarboxylic acid, and acid anhydrides thereof.

The epoxy resin can be formed from a polycondensation reaction between bisphenol A and epichlorohydrin. Specific examples of useable commercially available epoxy resins include, but are not limited to, EPOMIK® R362, R364, R365, R366, R367, and R369 (from Mitsui Chemicals, Inc.); EPOTOHTO®YD-011, YD-012, YD-014, YD-904, and YD-017 (from Tohto Kasei CO., Ltd.); and EPIKOTE® 1002, 1004, and 1007 (from Shell Kagaku K. K.).

Specific examples of the colorant for use in the toner include, but are not limited to, carbon black, lamp black, iron black, ultramarine blue, Nigrosine dyes, Aniline Blue, Phthalocyanine Blue, HANSA YELLOW G, Rhodamine 6G Lake, chalco oil blue, chrome yellow, quinacridone, benzidine yellow, rose bengal, triarylmethane dyes, and monoazo and disazo dyes and pigments. These colorants can be used alone or in combination.

The toner may optionally include a magnetic material. Specific examples of the magnetic materials include, but are not limited to, powders of ferromagnets (e.g., iron, cobalt), magnetite, hematite, Li ferrite, Mn—Zn ferrite, Cu—Zn ferrite, Ni—Zn ferrite, and Ba ferrite.

In order to sufficiently control triboelectric chargeability of the toner, the toner may include a charge controlling agent such as metal complex salts of monoazo dyes, nitrohumic acid and salts thereof, amino compounds of metal complexes of salicylic acid, naphthoic acid, and dicarboxylic acid with Co, Cr, Fe, etc., quaternary ammonium salts, and organic dyes.

The toner may optionally include a release agent, if desired. Specific examples of usable release agents include, but are not limited to, low-molecular-weight polypropylene, low-molecular-weight polyethylene, carnauba wax, microcrystalline wax, jojoba wax, rice wax, and montanic acid wax. These waxes can be used alone or in combination.

The toner may include other additives. To produce high quality images, the toner preferably has good fluidity. As a fluidity improving agent, particles of a hydrophobized metal oxide, a lubricant, and the like, are preferably added to the toner. As an external additive, particles of a metal oxide, a resin, a metal soap, and the like, can be added. Specific examples of usable external additives include, but are not limited to, fluorocarbon resins such as polytetrafluoroethylene; lubricants such as zinc stearate; abrasive agents such as cerium oxide and silicon carbide; fluidity improving agents such as inorganic oxides such as SiO₂ and TiO₂, the surface of which is hydrophobized; caking preventive; and surface-treated compounds thereof. To improve fluidity of the toner, hydrophobized silica is preferably used.

The toner preferably has a weight average particle diameter of from 3.0 to 9.0 μm, and more preferably from 3.5 to 7.5 μm. The particle diameter of a toner can be measured using COULTER COUNTER (from Beckman Coulter K. K.).

The developer includes the toner in an amount of from 2 to 25 parts by weight, and preferably from 3 to 20 parts by weight, per 100 parts by weight of the carrier.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

### Preparation of Carrier 1

A mixture including Fe₂O₃, CuO, and ZnO is pulverized into particles having a particle diameter of 1 μm or less using a wet ball mill. The pulverized particles are mixed with a polyvinyl alcohol, and the mixture is subjected to granulation using a spray drier. The granulated particles are calcined in an electric furnace, and the calcined particles are subjected to pulverization, classification, and size control. Thus, a core material 1 is prepared.

As a result of a componential analysis, the core material 1 includes Fe₂O₃, CuO, and ZnO in amounts of 46, 27, and 27% by mole, respectively.

Next, a mixture liquid including a silicone resin (SR2411 from Dow Corning Toray Silicone Co., Ltd.) and alumina particles having a weight average particle diameter of 0.3 μm in an amount of 20% by weight based on solid components of the silicon resin is prepared. The mixture liquid is poured into a glass container containing zirconia beads having a diameter of 0.5 mm and shaken for 2 hours using a paint shaker, to prepare a dispersion. The dispersion is diluted so that the dispersion includes solid components in an amount of 10% by weight. An aminosilane coupling agent having the following formula:

H₂N(CH₂)₃Si(OCH₃)₃

in an amount of 3% by weight based on solid components of the silicone resin is further added to the diluted dispersion. Thus, a cover layer coating liquid is prepared.

The cover layer coating liquid is coated on the surface of the core material 1 using a fluidized bed coating device in an atmosphere of 100° C. at a rate of 50 g/min. The coated core material is further heated for 2 hours at 250° C. Thus, a carrier 1 having a cover layer having a thickness of 0.6 μm is prepared. Properties of the carrier 1 are shown in Table 1.

### Preparation of Toner

First, 100 parts of a polyester resin, 3.5 parts of a quinacridone magenta pigment, and 4 parts of a fluorine-containing quaternary ammonium salt are mixed using a blender. The mixture is melt-kneaded using a double-screw extruder, and allowed to stand to cool. The cooled mixture is then coarsely pulverized using a cutter mill, finely pulverized using a jet stream pulverizer, and classified using a wind power classifier. Thus, mother toner particles having a weight average particle diameter of 6.8 μm and an absolute specific gravity of 1.20 are prepared.

Furthermore, 100 parts of the mother toner particles are mixed with 0.8 parts of hydrophobized silica particles (R972 from Nippon Aerosil Co., Ltd.) using a HENSCHEL MIXER. Thus, a toner is prepared.

### Preparation of Developer

To prepare a developer, 100 parts of the carrier 1 are mixed with 8 parts of the above-prepared toner using a ball mill for 20 minutes.

### Comparative Example 1

The procedure for preparation of the carrier 1 in Example 1 is repeated except that the alumina particles having a weight average particle diameter of 0.3 μm are not added to the cover layer. Thus, a carrier 2 having a cover layer having a thickness of 0.6 μm is prepared. Properties of the carrier 2 are shown in Tables 1-1 and 1-2.

A developer including the carrier 2 is prepared in the same manner as Example 1.

### Comparative Example 2

The procedure for preparation of the carrier 1 in Example 1 is repeated except that the mixture liquid including a silicone resin (SR2411 from Dow Corning Toray Silicone Co., Ltd.) and alumina particles having a weight average particle diameter of 0.3 μm in an amount of 20% by weight based on solid components of the silicon resin is agitated for 10 minutes using a stirrer, instead of using the paint shaker. Thus, a carrier 3 having a cover layer having a thickness of 0.6 μm is prepared. Properties of the carrier 3 are shown in Tables 1-1 and 1-2.

A developer including the carrier 3 is prepared in the same manner as Example 1.

### Comparative Example 3

The procedure for preparation of the carrier 1 in Example 1 is repeated except that the alumina particles having a weight average particle diameter of 0.3 μm are replaced with alumina particles having a weight average particle diameter of 0.7 μm. Thus, a carrier 4 having a cover layer having a thickness of 0.6 μm is prepared. Properties of the carrier 4 are shown in Tables 1-1 and 1-2.

A developer including the carrier 4 is prepared in the same manner as Example 1.

### Example 2

The procedure for preparation of the carrier 1 in Example 1 is repeated except that the amount of the alumina particles having a weight average particle diameter of 0.3 μm is changed from 20% by weight to 40% by weight based on solid components of the silicon resin. Thus, a carrier 5 having a cover layer having a thickness of 0.6 μm is prepared. Properties of the carrier 5 are shown in Tables 1-1 and 1-2.

A developer including the carrier 5 is prepared in the same manner as Example 1.

### Comparative Example 4

The procedure for preparation of the carrier 1 in Example 1 is repeated except that the core material 1 is replaced with a core material 2 prepared under another classification and size control conditions. Thus, a carrier 6 having a cover layer having a thickness of 0.6 μm is prepared. Properties of the carrier 6 are shown in Tables 1-1 and 1-2.

A developer including the carrier 6 is prepared in the same manner as Example 1.

### Comparative Example 5

The procedure for preparation of the carrier 1 in Example 1 is repeated except that the core material 1 is replaced with a core material 3 prepared under yet another classification and size control conditions. Thus, a carrier 7 having a cover layer having a thickness of 0.6 μm is prepared. Properties of the carrier 7 are shown in Tables 1-1 and 1-2.

A developer including the carrier 7 is prepared in the same manner as Example 1.

### Example 3

The procedure for preparation of the carrier 1 in Example 1 is repeated except that the core material 1 is replaced with a core material 4 prepared under yet another classification and size control conditions. Thus, a carrier 8 having a cover layer having a thickness of 0.6 μm is prepared. Properties of the carrier 8 are shown in Tables 1-1 and 1-2.

A developer including the carrier 8 is prepared in the same manner as Example 1.

### Example 4

A Fe₂O₃ is pulverized into particles having a particle diameter of 1 μm or less using a wet ball mill. The pulverized particles are mixed with a polyvinyl alcohol, and the mixture is subjected to granulation using a spray drier. The granulated particles are calcined in an electric furnace, and the calcined particles are subjected to pulverization, classification, and size control. Thus, a core material 5 is prepared.

The cover layer coating liquid prepared in Example 1 is coated on the core material 5 in the same manner as Example 1. The coated core material is further heated for 2 hours at 250° C. Thus, a carrier 9 having a cover layer having a thickness of 0.6 μm is prepared. Properties of the carrier 9 are shown in Tables 1-1 and 1-2.

A developer including the carrier 9 is prepared in the same manner as Example 1.

### Example 5

The procedure for preparation of the carrier 1 in Example 1 is repeated except that 20% by weight of the alumina particles having a weight average particle diameter of 0.3 μm are replaced with 40% by weight of silica particles having a weight average particle diameter of 0.03 μm, based on solid components of the silicon resin. Thus, a carrier 10 having a cover layer having a thickness of 0.6 μm is prepared. Properties of the carrier 10 are shown in Tables 1-1 and 1-2.

A developer including the carrier 10 is prepared in the same manner as Example 1.

### Example 6

The procedure for preparation of the carrier 1 in Example 1 is repeated except that 20% by weight of the alumina particles having a weight average particle diameter of 0.3 μm are replaced with 40% by weight of titanium oxide particles having a weight average particle diameter of 0.03 μm, based on solid components of the silicon resin. Thus, a carrier 11 having a cover layer having a thickness of 0.6 μm is prepared. Properties of the carrier 11 are shown in Tables 1-1 and 1-2.

A developer including the carrier 11 is prepared in the same manner as Example 1.

TABLE 1-1

| | | | Magnetic | |
|---|---|---|---|---|
| | Core | Core | Moment | |
| Carrier | Material | Composition | (emu/g) | E10/E100 |
| 1 | 1 | Cu—Zn Ferrite | 56 | 1.10 |
| 2 | 1 | Cu—Zn Ferrite | 56 | 1.28 |
| 3 | 1 | Cu—Zn Ferrite | 56 | 1.15 |
| 4 | 1 | Cu—Zn Ferrite | 56 | 1.23 |
| 5 | 1 | Cu—Zn Ferrite | 56 | 1.15 |
| 6 | 2 | Cu—Zn Ferrite | 56 | 1.11 |
| 7 | 3 | Cu—Zn Ferrite | 56 | 1.08 |
| 8 | 4 | Cu—Zn Ferrite | 56 | 1.10 |
| 9 | 5 | Magnetite | 81 | 1.14 |
| 10 | 1 | Cu—Zn Ferrite | 56 | 1.17 |
| 11 | 1 | Cu—Zn Ferrite | 56 | 1.18 |

TABLE 1-2

| | |
|---|---|
| | Particle Diameter Distribution |
| Dw | (% by weight) |

| Carrier | (μm) | Dw/Dp | 20 μm or less | 36 μm or less |
|---|---|---|---|---|
| 1 | 27 | 1.1 | 6 | 91 |
| 2 | 27 | 1.1 | 6 | 91 |
| 3 | 27 | 1.1 | 6 | 91 |
| 4 | 27 | 1.1 | 6 | 91 |
| 5 | 27 | 1.1 | 6 | 91 |
| 6 | 25 | 1.2 | 15 | 95 |
| 7 | 38 | 1.2 | 0 | 46 |
| 8 | 28 | 1.1 | 4 | 90 |
| 9 | 27 | 1.1 | 6 | 91 |
| 10 | 27 | 1.1 | 6 | 91 |
| 11 | 27 | 1.1 | 6 | 91 |

### Evaluations

Each of the developers prepared above is set in an image forming apparatus in which a photoconductor has a diameter of 30 mm and a linear speed of 240 mm/sec, a developing sleeve has a diameter of 18 mm and a linear speed of 408 mm/sec, and the minimum distance between the developing sleeve and the photoconductor is 0.3 mm. A total weight of the developer contained in a developing device is 280 g. A position in which a doctor magnetic pole facing a doctor blade expresses the maximum magnetic flux density in the direction of a normal line is roughly set to 0 degree.

The produced images are subjected to the following evaluations.

### (1) Granularity

Granularity is defined as the following equation (at a range of lightness of from 50 to 80):

G=exp(aL+b)∫{WS(f)}^{1/2}VTF(f)df

wherein G represents a granularity, L represents an average lightness, f represents a spatial frequency (cycle/mm), WS (f) represents a power spectrum of a lightness variation, VTF(f) represents visual spatial modulation transfer function, and a and b each represent a coefficient. The granularity is graded as follows.

A (Very good): not less than 0 and less than 0.1

B (Good): not less than 0.1 and less than 0.2

C (Usable): not less than 0.2 and less than 0.3

D (Nonusable): not less than 0.3

### (2) Background Fouling

Background portions of the produced images are visually observed and graded as follows.

A: Very good

B: Good

C: Usable

D: Nonusable

### (3) Carrier Deposition

Carrier particles deposited on the photoconductor are transferred onto an adhesive tape. This is because not all the carrier particles deposited on the photoconductor are to be transferred onto a transfer paper. Specifically, background portions (i.e., non-irradiated portions) are developed under the charging potential (Vd) of −750 V and the developing bias (Vb) of DC −400 V. The number of carrier particles deposited on an area of 30 cm² is directly counted, and graded as follows.

A: Very good

B: Good

C: Usable

D: Nonusable

(4) Background Fouling after 10K Running Test

A running test is performed in which 10,000 sheets of a chart having an image area ratio of 6% are continuously produced while supplying a toner. Background portions of the produced images are visually observed and graded as follows.

A: Very good

B: Good

C: Usable

D: Nonusable

The results of the evaluations are shown in Table 2.

TABLE 2

Evaluations

| | Carrier | (1) | (2) | (3) | (4) |
|---|---|---|---|---|---|
| Example 1 | 1 | B | B | B | B |
| Comparative Example 1 | 2 | C | D | B | D |
| Comparative Example 2 | 3 | B | B | B | D |
| Comparative Example 3 | 4 | C | D | B | D |
| Example 2 | 5 | B | B | B | A |
| Comparative Example 4 | 6 | B | B | D | B |
| Comparative Example 5 | 7 | D | B | A | B |
| Example 3 | 8 | B | B | A | B |
| Example 4 | 9 | B | B | A | B |
| Example 5 | 10 | B | B | B | B |
| Example 6 | 11 | B | B | B | B |

This document claims priority and contains subject matter related to Japanese Patent Application No. 2007-207621, filed on Aug. 9, 2007, the entire contents of which are incorporated herein by reference.

Having now fully described the invention, it will be apparent to one of ordinary skill in the art that many changes and modifications can be made thereto without departing from the spirit and scope of the invention as set forth therein.

1. An image forming apparatus, comprising:
a developer bearing member, being rotatable and internally comprising a magnetic member, configured to bear a two-component developer comprising a toner and a magnetic carrier; and
a developer control member, being magnetic, configured to control a layer thickness of the two-component developer borne on the developer bearing member;
wherein the electrostatic latent image on the image bearing member is developed with the toner to form a toner image by an action of an electric field formed between the image bearing member and the developer bearing member,
wherein the magnetic carrier comprises magnetic core particles having a cover layer on the surfaces thereof,
wherein the cover layer comprises fine particles having a weight average particle diameter of from 0.02 to 0.5 μm,
wherein magnetic the carrier has a weight average particle diameter of from 22 to 32 μm, and
wherein the magnetic carrier has a ratio (E10/E100) of from 1.00 to 1.20,
wherein the ratio (E10/E100) is a ratio of a total energy (E10) at a leading edge speed of a blade of 10 mm/s to a total energy (E100) at a leading edge speed of the blade of 100 mm/s, measured using a power rheometer at an angle of approach of −5°.

2. The image forming apparatus according to claim 1, wherein the magnetic carrier has a ratio (Dw/Dp) of a weight average particle diameter (Dw) to a number average particle diameter (Dp) of from 1.0 to 1.20, and
wherein the magnetic carrier comprises
particles having a particle diameter of from 0.02 to 20 μm in an amount of from 0 to 7% by weight, and
particles having a particle diameter of from 0.02 to 36 μm in an amount of from 90 to 100% by weight, based on the weight of the magnetic carrier.

3. The image forming apparatus according to claim 1, wherein the fine particles comprise at least one member selected from the group consisting of a silicon oxide, a titanium oxide, an aluminum oxide and mixtures thereof.

4. The image forming apparatus according to claim 1, wherein the magnetic core particles have a magnetization of from 65 to 120 emu/g in a magnetic field of 1 KOe.

5. The image forming apparatus according to claim 1, wherein the cover layer comprises a silicone resin.

6. The image forming apparatus according to claim 5, wherein the cover layer further comprises an aminosilane coupling agent.

7. The image forming apparatus according to claim 1, which is an electrophotographic printer.

8. The image forming apparatus according to claim 1, which comprises
a photoconductor serving as an image bearing member;
a charging device, an optical writing device, a developing device, a transfer device, a fixing device, a cleaning device, and a decharging device, provided around the photoconductor.

9. The image forming apparatus according to claim 8, wherein the photoconductor is driven to rotate by a driving device.

10. The image forming apparatus according to claim 8, wherein the photoconductor comprises a cored bar comprising aluminum and an organic photosensitive layer formed on the surface of the cored bar.

11. The image forming apparatus according to claim 1, wherein the magnetic core particles are selected from the group consisting of iron, cobalt, magnetite, hematite, Li ferrite, Mn—Zn ferrite, Cu—Zn ferrite, Ni—Zn ferrite, Ba ferrite, Mn ferrite and mixtures thereof.

12. The image forming apparatus according to claim 1, wherein a content of the fine particles included in the cover layer is from 2 to 200% by weight based on solid components of resins in the cover layer.

13. The image forming apparatus according to claim 5, wherein the silicone resin comprises at least one of the following repeating units: 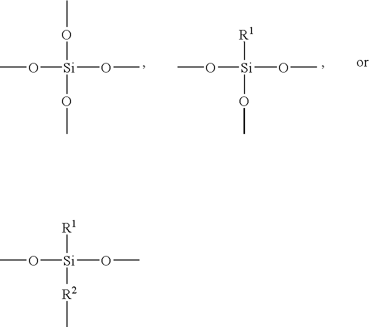
wherein R¹ represents a hydrogen atom, a halogen atom, a hydroxyl group, a methoxy group, a lower alkyl group having 1 to 4 carbon atoms, or an aryl group; and R² represents an alkylene group having 1 to 4 carbon atoms or an arylene group.

14. The image forming apparatus according to claim 5, wherein the silicone resin is a modified silicone resin.

15. The image forming apparatus according to claim 5, wherein the silicone resin is selected from the group consisting of epoxy-modified silicone resin, acryl-modified silicone resin, phenol-modified silicone resin, urethane-modified silicone resin, polyester-modified silicone resin, alkyd-modified silicone resin and mixtures thereof.

16. The image forming apparatus according to claim 1, wherein the cover layer has a thickness of from 0.02 to 1 μm.
